(19) United States
(12) Patent Application Publication
(10) Pub. No.: US 2017/0228408 A1
(43) Pub. Date: Aug. 10, 2017

(54) DATA MANAGEMENT APPARATUS AND METHOD THEREFOR

(71) Applicant: FUJITSU LIMITED, Kawasaki-shi (JP)

(72) Inventors: Atsushi Sato, Kobe (JP); Yosuke NAKA, Kobe (JP); Masato Yamashita, kobe (JP); Makoto Adachi, Akashi (JP); Naohiro Kishishita, Akashi (JP); Takayuki Nagai, Kako (JP); Shunichi Obinata, Kawasaki (JP); Takeya Mutoh, Akashi (JP)

(73) Assignee: FUJITSU LIMITED, Kawasaki-shi (JP)

(21) Appl. No.: 15/413,522

(22) Filed: Jan. 24, 2017

(30) Foreign Application Priority Data
Feb. 10, 2016 (JP) 2016-023309

(51) Int. Cl. G06F 17/30

(52) U.S. Cl. CPC G06F 17/30345; G06F 17/30117

(57) ABSTRACT

A data management device includes a memory and processor configured to perform a process including storing a management information piece in the memory each time a request for manipulation issued during execution of each processing program is a request for acquiring, referencing, or updating a data set, the management information piece associating the processing program with the data set targeted for the manipulation; identifying, upon input of notice indicating termination of use of a first processing program, one or more data sets associated with the first processing program based on one or more management information pieces corresponding to the first processing program; and determining, for each of the identified data sets, that the identified data set is deletable when, in the memory, there is no management information piece corresponding to a second processing program being different from the first processing program and associated with the identified data set.

### CROSS-REFERENCE TO RELATED APPLICATION

This application is based upon and claims the benefit of priority of the prior Japanese Patent Application No. 2016-023309, filed on Feb. 10, 2016, the entire contents of which are incorporated herein by reference.

### FIELD

The embodiments discussed herein are related to a data management apparatus and method therefor.

### BACKGROUND

Cloud services are widely used in recent years. Cloud services allow data and software to be available via a network. For example, users use Web browsers running on their own computers to thereby access software and hardware resources (such as computation and storage resources) provided by cloud service providers via a network. There are widely three cloud service models: Software as a Service (SaaS); Platform as a Service (PaaS); and Infrastructure as a Service (IaaS). SaaS is a service that provides software, such as e-mail, groupware, customer management systems, and accounting software, through a network. PaaS is a service that provides functions of, for example, an operating system (OS), middleware, and an application server as an application software development and execution environment through a network. IaaS is a service that provides disk space for storing data, management functions, or the like, through a network.

Users wanting to use PaaS to develop and/or execute application software subscribe to services available in PaaS offerings. Further, the users also subscribe to storage resources, such as relational database services (RDSs) and object storage, available through IaaS. For example, a user using a log service in PaaS stores logs of application software provided by PaaS in an IaaS storage resource. Users are charged according to their usage of services and resources (such as operating time and communication traffic). In addition, users are able to terminate contracts for services and resources that are no longer needed. For example, if a user terminates a license contract of application software provided by PaaS, charges for the application software contract are stopped. Note that if data associated with the cancelled application software, such as logs output from the application software, remains in IaaS storage resources, the user will keep charged for the IaaS service based on the storage usage of the associated data.

There is a proposed pricing method associated with cloud services, allowing efficient recovery of costs of computer resources prepared by a service provider according to changes (i.e., increases and decreases) in the amount of computer resources requested to be provided. This pricing method stores information on the costs of virtualization apparatuses that provide their computer resources upon request of a user as well as information on the amount of computer resources provided to the user, and calculates the price for providing the computer resources based on the costs and the provision amount.

See, for example, Japanese Laid-open Patent Publication No. 2010-286925.

### SUMMARY

According to one embodiment, there is provided a non-transitory computer-readable storage medium storing a data management program that causes a processor of a computer including a memory to perform a process. The process includes storing a management information piece in the memory each time a request for manipulation issued during execution of each processing program used for data manipulation is a request for acquisition, reference, or update of a data set, the management information piece associating the processing program with the data set targeted for the manipulation; identifying, upon input of notice indicating termination of use of a first processing program into the computer, one or more data sets associated with the first processing program based on one or more management information pieces corresponding to the first processing program; and determining, for each of the identified data sets, that the identified data set is deletable when, in the memory, there is no management information piece corresponding to a second processing program being different from the first processing program and associated with the identified data set.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a system according to a first embodiment;

FIG. 2 illustrates an example of a system according to a second embodiment;

FIG. 3 illustrates an example of a data management method implemented in a cloud service delivery system according to the second embodiment;

FIG. 4 illustrates an example of hardware capable of implementing functions of individual systems according to the second embodiment;

FIG. 5 is a block diagram illustrating an example of functions of a data managing unit according to the second embodiment;

FIG. 6 illustrates an example of a master information table according to the second embodiment;

FIG. 7 illustrates an example of a request information table according to the second embodiment;

FIG. 8 illustrates an example of a remaining data management table according to the second embodiment;

FIG. 9 is a first flow diagram illustrating a flow of processing executed by the data managing unit according to the second embodiment;

FIG. 10 is a second flow diagram illustrating the flow of the processing executed by the data managing unit according to the second embodiment;

FIG. 11 is a third flow diagram illustrating the flow of the processing executed by the data managing unit according to the second embodiment;

FIG. 12 is a fourth flow diagram illustrating the flow of the processing executed by the data managing unit according to the second embodiment;

FIG. 13 is a fifth flow diagram illustrating the flow of the processing executed by the data managing unit according to the second embodiment;

FIG. 14 is a sixth flow diagram illustrating the flow of the processing executed by the data managing unit according to the second embodiment;

FIG. 15 illustrates an example of a master information table according to a modification of the second embodiment;

FIG. 16 is a first flow diagram illustrating a flow of processing executed by the data managing unit according to the modification of the second embodiment;

FIG. 17 is a second flow diagram illustrating the flow of the processing executed by the data managing unit according to the modification of the second embodiment;

FIG. 18 is a third flow diagram illustrating the flow of the processing executed by the data managing unit according to the modification of the second embodiment; and

FIG. 19 is a fourth flow diagram illustrating the flow of the processing executed by the data managing unit according to the modification of the second embodiment.

### DESCRIPTION OF EMBODIMENTS

As mentioned above, even if the user terminates the license contract of the application software provided by PaaS, if the associated data in the IaaS storage resources remains undeleted, charges for the storage resource use by the remaining associated data will be borne by the user. However, if the amount of the associated data of the cancelled application software is large, it would be difficult in practice for the user to accurately track down all the data. Thus, even if the user tries to manually delete the associated data, it is highly likely that some part of the associated data still remains in the storage resources. Then, the user continues to be charged for the remaining unwanted associated data.

Note that, in many cases, a service provider makes agreements with its user that the service provider will not refer to storage resources used by the application software to which the user has subscribed. It will therefore not happen that, under normal circumstances, the service provider deletes the data associated with the cancelled application software from the storage resources. As a result, the user continues to be charged for remaining associated data that the user has failed to delete.

Several embodiments will be described below with reference to the accompanying drawings. In the following description and the accompanying drawings, like reference numerals refer to like elements having substantially the same functions, and a repeated description thereof may be omitted.

### (a) First Embodiment

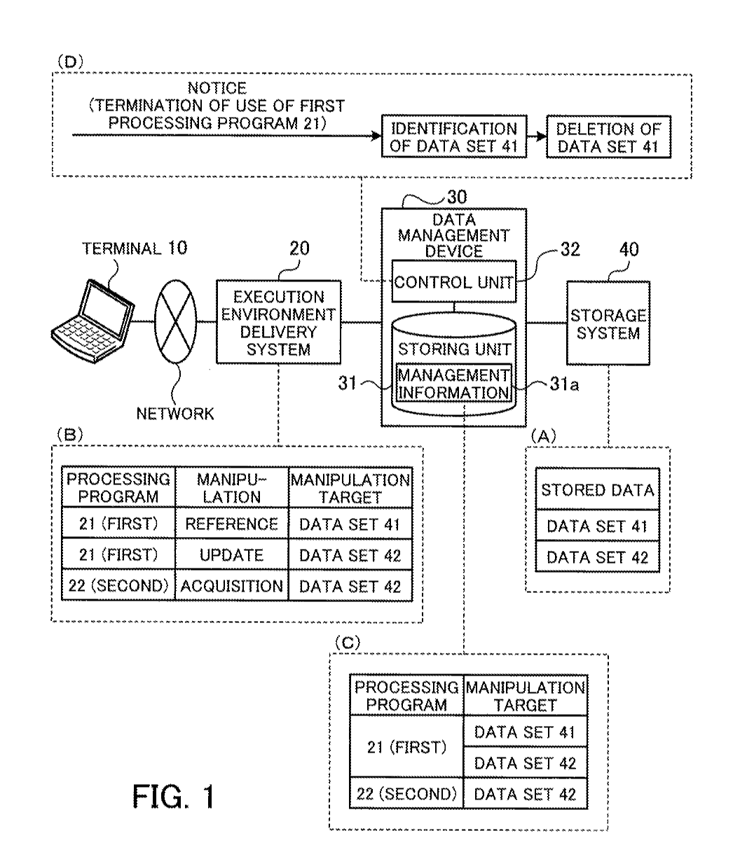

A first embodiment is described next with reference to FIG. 1. The first embodiment is directed to a system for providing a cloud environment for developing and executing processing programs, such as application software programs, and provides a mechanism for allowing appropriate deletion of data associated with a processing program at the time of cancellation of the processing program.

FIG. 1 illustrates an example of the system according to the first embodiment. The system according to the first embodiment includes a terminal 10, an execution environment delivery system 20, a data management device 30, and a storage system 40, as illustrated in FIG. 1. Note that the execution environment delivery system 20 and the data management device 30 function, for example, as a system for providing PaaS capabilities (a PaaS system). In addition, the storage system 40 functions as a system for providing IaaS capabilities (an IaaS system).

The terminal 10 is a user's computer, and is connected to the execution environment delivery system 20 via a network. The network is, for example, a wide-area network such as the Internet, or a local communication network such as a wired or wireless local area network (LAN). The execution environment delivery system 20 includes one or more computers equipped with a processor and memory. The execution environment delivery system 20 delivers an environment for developing and executing processing programs to the terminal 10 as services available through the network. For example, the execution environment delivery system 20 delivers functions of an operating system (OS), middleware, an application server, and the like, to the terminal 10 as services.

The data management device 30 monitors communications (for example, Hypertext Transfer Protocol (HTTP) communications) between processing programs executed on the execution environment delivery system 20 and the storage system 40. Note that the data management device 30 is described further later on. The storage system 40 includes one or more storage devices equipped with a memory unit, such as a hard disk drive (HDD) or solid state device (SSD). The storage system 40 stores therein data associated with the processing programs executed on the execution environment delivery system 20. For example, logs output from the processing programs are stored in the storage system 40. In the example of FIG. 1, data sets 41 and 42 are stored in the storage system 40 (see (A) in FIG. 1).

Further details of the data management device 30 are described next. The data management device 30 includes a storing unit 31 and a control unit 32, as illustrated in FIG. 1. The storing unit 31 is a volatile memory unit, such as random access memory (RAM), or a non-volatile memory unit, such as a HDD or flash memory. The control unit 32 is a processor, such as a central processing unit (CPU) or digital signal processor (DSP). Note however that the control unit 32 may be an electronic circuit, such as an application specific integrated circuit (ASIC) or field programmable gate array (FPGA). The control unit 32 performs a program stored in the storing unit 31 or different memory.

The storing unit 31 stores therein management information 31a. The management information 31a associates each processing program with one or more manipulation-target data sets. When a manipulation request issued during the execution of each processing program describing processing of data manipulation is a request for acquisition, reference, or update of a data set, the control unit 32 stores, in the management information 31a of the storing unit 31, an information piece associating the processing program with the manipulation-target data set. Note that, for the purpose of illustration, a process generated during the execution of a processing program, carrying out a procedure, such as requesting manipulation, may be referred to as the processing program performing the procedure.

For example, in order for a first processing program 21 running on the execution environment delivery system 20 to refer to the data set 41 stored in the storage system 40, the first processing program 21 transmits, to the storage system 40, a request for a “reference” manipulation to the data set 41. In this case, the control unit 32 stores, in the management information 31a of the storing unit 31, an information piece associating the first processing program 21 with the data set 41.

In addition, in order for the first processing program 21 running on the execution environment delivery system 20 to update the data set 42 stored in the storage system 40, the first processing program 21 transmits, to the storage system 40, a request for an “update” manipulation for the data set 42. In this case, the control unit 32 stores, in the management information 31a of the storing unit 31, an information piece associating the first processing program 21 with the data set 42.

Further, in order for a second processing program 22 running on the execution environment delivery system 20 to acquire the data set 42 stored in the storage system 40, the second processing program 22 transmits, to the storage system 40, a request for an “acquisition” manipulation for the data set 42. In this case, the control unit 32 stores, in the management information 31a of the storing unit 31, an information piece associating the second processing program 22 with the data set 42.

As described above, after the requests for the “reference”, “update”, and “acquisition” manipulations are made from the first processing program 21 and the second processing program 22 (see (B) in FIG. 1), the management information 31a as illustrated in (C) of FIG. 1 is stored in the storing unit 31. Note that, in the case where a request for a “deletion” manipulation for the data set 41 is made, the control unit 32 deletes information pertaining to the data set 41 from the management information 31a. Similarly, in the case where a request for a “deletion” manipulation for the data set 42 is made, the control unit 32 deletes information pertaining to the data set 42 from the management information 31a.

Upon input of notice indicating the termination of the use of the first processing program 21, the control unit 32 refers to the management information 31a to identify one or more manipulation-target data sets associated with the first processing program 21, as illustrated in (D) of FIG. 1. In the example of (C) in FIG. 1, the first processing program 21 is associated with the data sets 41 and 42 by the management information 31a. In this case, the control unit 32 identifies the data sets 41 and 42 as manipulation-target data sets associated with the first processing program 21.

Then, as for each of the one or more identified manipulation-target data sets, if the manipulation-target data set is not associated with the second processing program 22 being different from the first processing program 21, the control unit 32 deletes the manipulation-target data set. In the example of (C) in FIG. 1, the data set 42 is associated with the second processing program 22 by the management information 31a. On the other hand, the data set 41 is not associated with the second processing program 22. In this case, the control unit 32 deletes the data set 41 from the storage system 40, as illustrated in (D) of FIG. 1.

As described above, by monitoring manipulation requests transferred between the processing programs and the storage system 40 and holding information on the association between the processing programs and manipulation-target data sets, it is possible to identify one or more data sets associated with each of the processing programs without the service provider referring to storage resources. Therefore, the application of the mechanism of the first embodiment allows the service provider to readily delete data sets associated with a cancelled processing program from the storage system 40.

In addition, even in the case where there is one or more data sets shared between the cancelled processing program and a different processing program, the service provider is able to identify deletable data sets associated with the cancelled processing program in consideration of the effects on the different processing program. As a result, it is possible to reduce the occurrence of deletable data sets associated with the cancelled processing program being left at the termination of the use of the processing program, compared to the case where the user deletes the associated data sets by him/herself. Further, it is possible to reduce the workload and financial burden on the user. The first embodiment has been described thus far.

### (b) Second Embodiment

Next, a second embodiment is described. The second embodiment is directed to a system for providing a cloud environment for developing and executing application software programs, and provides a mechanism for allowing appropriate deletion of data associated with an application software program at the time of cancellation of the application software program.

b-1. System

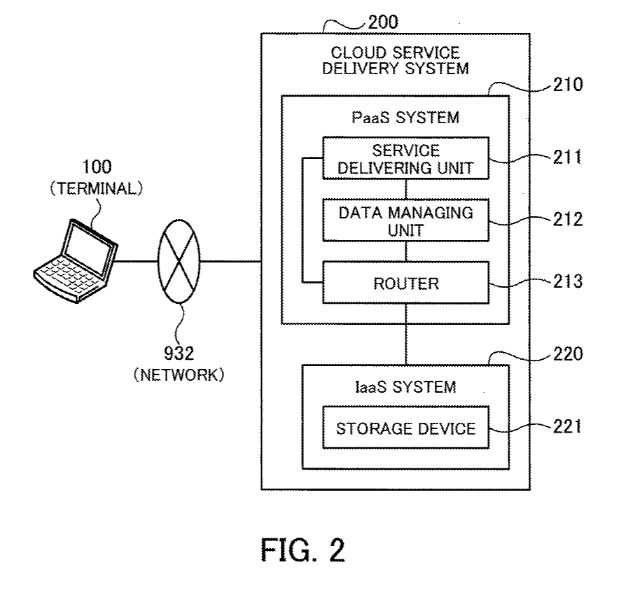

The system according to the second embodiment is described with reference to FIG. 2. FIG. 2 illustrates an example of the system according to the second embodiment. Note that the system to which a technique of the second embodiment is applicable is not limited to the example of FIG. 2; however, for the purpose of illustration, the following description uses the system of FIG. 2 as an example. The system of the second embodiment includes a terminal 100 and a cloud service delivery system 200, as illustrated in FIG. 2. The terminal 100 is a computer used by the user to access services provided by the cloud service delivery system 200 through a network 932. The network 932 is, for example, a wide-area network such as the Internet, or a local communication network such as a wired or wireless local area network (LAN).

The cloud service delivery system 200 includes a PaaS system 210 and an IaaS system 220. The PaaS system 210 is implemented using one or more computers and delivers, as services, functions of an operating system, middleware, an application server, and the like, to the terminal 10 through the network 932. The IaaS system 220 delivers, as services, storage resources for storing data through the network 932. For example, the IaaS system 220 provides relational database services (RDSs).

The PaaS system 210 includes a service delivering unit 211, a data managing unit 212, and a router 213. The service delivering unit 211 delivers an environment for developing and executing application software programs to the terminal 100 via the network 932. For example, the service delivering unit 211 executes application software programs developed by the user using the terminal 100. Logs and other data output from each of the application software programs executed by the service delivering unit 211 are sent to the IaaS system 220 via the router 213. Note that, for the purpose of illustration, a process generated during the execution of an application software program, carrying out a procedure, such as outputting data, may be referred to as the application software program performing the procedure.

The data managing unit 212 monitors HTTP communications between the PaaS system 210 and the IaaS system 220 via the router 213. Based on the results of monitoring the HTTP communications, the data managing unit 212 associates the application software programs with data sets sent to the IaaS system 220. Then, at the time of cancellation of an application software program, the data managing unit 212 identifies deletable data sets amongst data sets associated with the application software program, and deletes the identified data sets from the IaaS system 220.

The IaaS system 220 includes a storage device 221. The storage device 221 includes one or more memory units, such as HDDs or SSDs, and provides memory areas for data sets and manages the data sets stored in the memory areas. The example of FIG. 2 depicts only one storage device 221 for the purpose of illustration; however, a plurality of storage devices may be provided in the IaaS system 220.

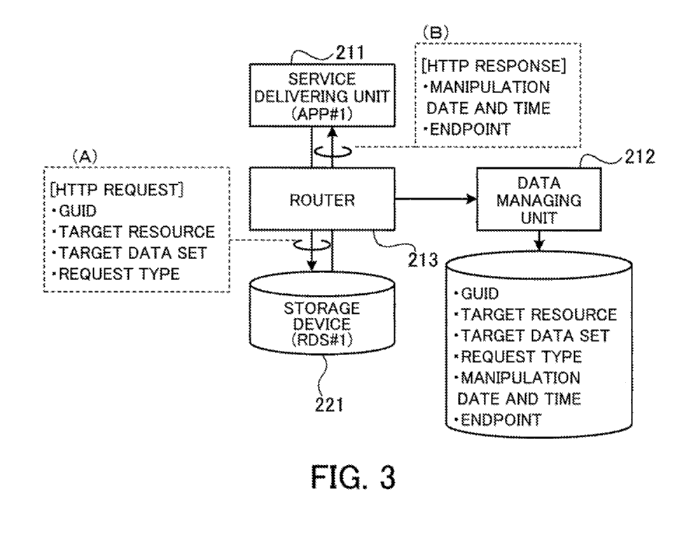

Next described are the flow of HTTP communications between the PaaS system 210 and the IaaS system 220 and a data management method mainly implemented by the data managing unit 212, with reference to FIG. 3. FIG. 3 illustrates an example of a data management method implemented in the cloud service delivery system according to the second embodiment. The example of FIG. 3 depicts HTTP communications taking place via the router 213 when an application software program APP#1 accesses a data set in a database RDS#1, as well as a situation where the data managing unit 212 accumulates information on this occasion.

In the case where APP#1 acquires a data set DT#1 stored in RDS#1, APP#1 issues an HTTP request with designation of a globally unique identifier (GUID) identifying APP#1, the target resource RDS#1, the target data set Urn, and a request type “GET”. In response to the HTTP request asking for a manipulation to acquire Urn, RDS#1 returns, to APP#1, an HTTP response including the manipulation date and time and an endpoint for identifying the manipulation target, together with DT#1.

Note that the endpoint is represented, for example, by an Internet Protocol address (IP address) of RDS#1, or a Uniform Resource Locator (URL) indicating the IP address of RDS#1 and the location of the data set in RDS#1. Hereinafter, for the purpose of illustration, the term RDS address refers to the IP address of an RDS and the term endpoint refers to the URL indicating an RDS address and a data set location. For example, in the case where the RDS address of RDS#1 is “192.168.0.1” and the data set DT#1 is found directly below the location specified by the RDS address, the endpoint is represented by, for example, “http://192.168.0.1/DT#1”.

The data managing unit 212 monitors HTTP communications taking place via the router 213 and acquires, from each HTTP request and its corresponding HTTP response, information such as a GUID, a target resource, a target data set, a request type, a manipulation date and time, and an endpoint. Then, the data managing unit 212 manages the acquired GUID, target resource, target data set, request type, manipulation date and time, and endpoint in association with each other. Note however that, when the endpoint includes information of the target data set as described above, the data managing unit 212 may manage the target data set and the endpoint without separating them.

When GUIDs and endpoints individually associated with each of the GUIDs have been acquired as described above, it is possible to identify mappings between application software programs and data sets used by the application software programs. That is, the service provider is able to acquire the mappings without referring to the data sets of the application software programs, stored in the RDSs. Then, when the user cancels an application software program, the service provider provides the user with information of data sets associated with the application software program, or deletes the data sets from an appropriate RDS on behalf of the user. As a result, it is possible to reduce the occurrence of unwanted data sets being left at the time of cancellation of the application software program, compared to the case where the user manually deletes the associated data sets. This prevents the user from being charged for the amount of the RDS used by the unwanted data.

Note that the range of data to which the service provider running the above-described cloud environment is able to refer is limited to data sets stored in resources by various services, data sets within a firewall, data sets exchanged through a router, data sets within an elastic load balancing (ELB) system, and data sets within a security group. In addition, as for storage resources such as RDSs and object storage, there are restrictions on referencing data sets of application software programs developed by users and data sets stored in the storage resources via services. The technique of the second embodiment utilizing the results of monitoring HTTP communications is preferable in such environments. The system has been described thus far.

b-2. Hardware

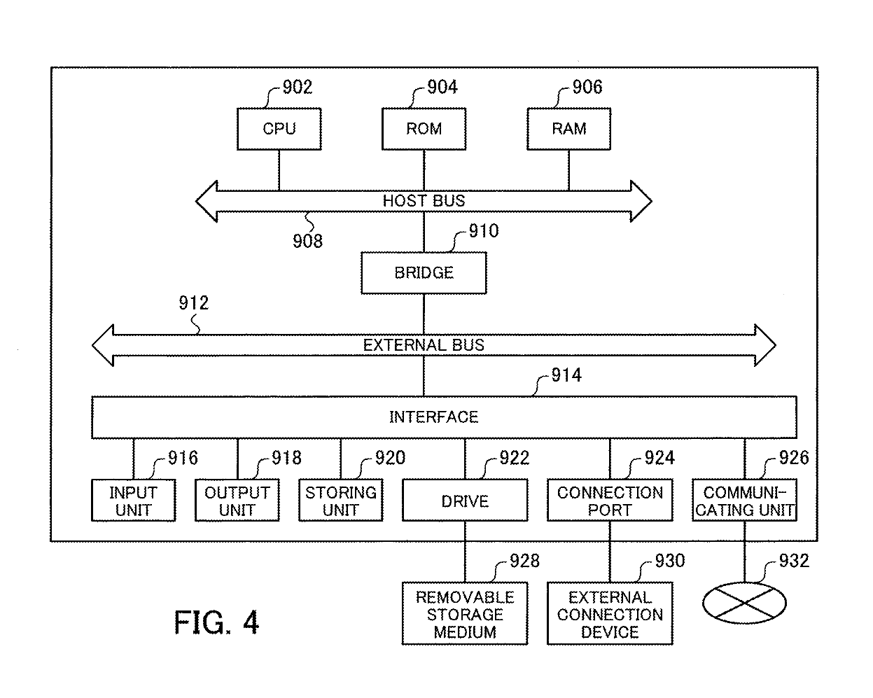

Next described is hardware of a computer capable of implementing functions of the cloud service delivery system 200 (the PaaS system 210 and the IaaS system 220) with reference to FIG. 4. Note that the functions of the terminal 100 may have the same hardware configuration as the computer illustrated in FIG. 4. FIG. 4 illustrates an example of hardware capable of implementing functions of individual systems according to the second embodiment. The functions of the cloud service delivery system 200 are implemented using, for example, hardware resources illustrated in FIG. 4. For example, the functions of the data managing unit 212 of the PaaS system 210 are implemented by controlling the hardware of FIG. 4 using a computer program. Note that the cloud service delivery system 200 may include a plurality of computers each having the hardware resources of FIG. 4.

The hardware mainly includes a CPU 902, read only memory (ROM) 904, RAM 906, a host bus 908, and a bridge 910, as illustrated in FIG. 4. Further, the hardware includes an external bus 912, an interface 914, an input unit 916, an output unit 918, a storing unit 920, a drive 922, a connection port 924, and a communicating unit 926. The CPU 902 functions, for example, as an arithmetic processing unit or a control device, and exercises control over all, or a part of, operations of the individual structural elements based on various programs recorded on the ROM 904, the RAM 906, the storing unit 920, or a removable storage medium 928. The ROM 904 is an example of memory units for storing, for example, programs to be loaded into the CPU 902 and data or the like to be used for calculation. The RAM 906 temporarily or permanently stores therein, for example, programs to be loaded into the CPU 902 as well as various parameters to change in the execution of the programs.

These structural elements are connected to each other, for example, via the host bus 908 capable of high-speed data transmission. On the other hand, the host bus 908 is connected, for example, through the bridge 910 to the external bus 912 with a relatively low data transmission speed. The input unit 916 is, for example, a mouse, a keyboard, a touch panel, a touch-pad, buttons, switches, levers or the like. Further, the input unit 916 may be a remote controller capable of transmitting a control signal using infrared or other radio waves. The output unit 918 is, for example, a display device such as a cathode ray tube (CRT), a liquid crystal display (LCD), a plasma display panel (PDP), or an electro-luminescence display (ELD). Further, an audio output device, such as a speaker or headphones, or a printer may be employed as the output unit 918. That is, the output unit 918 is a device capable of outputting information visually or audibly.

The storing unit 920 is a device for storing therein various types of data. The storing unit 920 is, for example, a magnetic storage device such as a HDD, or alternatively may be a semiconductor storage device such as a SSD and a RAM disk, an optical storage device, or a magneto-optical storage device. The drive 922 is a device for reading information recorded on the removable storage medium 928 and writing information to the removable storage medium 928. The removable storage medium 928 is, for example, a magnetic disk, an optical disk, a magneto-optical disk, or semiconductor memory. The connection port 924 is a port for connecting an external connection device 930, and is, for example, a universal serial bus (USB) port, an Institute of Electrical and Electronics Engineers (IEEE)-1394 port, a small computer system interface (SCSI), an RS-232C port, or an optical audio terminal. The external connection device 930 is, for example, a printer.

The communicating unit 926 is a communication device used to connect with a network 932. The communicating unit 926 is, for example, a wired or wireless LAN communication circuit, a wireless USB (WUSB) communication circuit, an optical communication circuit or router, an Asymmetric Digital Subscriber Line (ADSL) communication circuit or router, or a mobile network communication circuit. The network 932 connected to the communicating unit 926 is a network connected with a wire or wirelessly, and is, for example, the Internet, a LAN, a broadcasting network, or a satellite communication link. The hardware according to the second embodiment has been described thus far.

b-3. Functions of Data Managing Unit

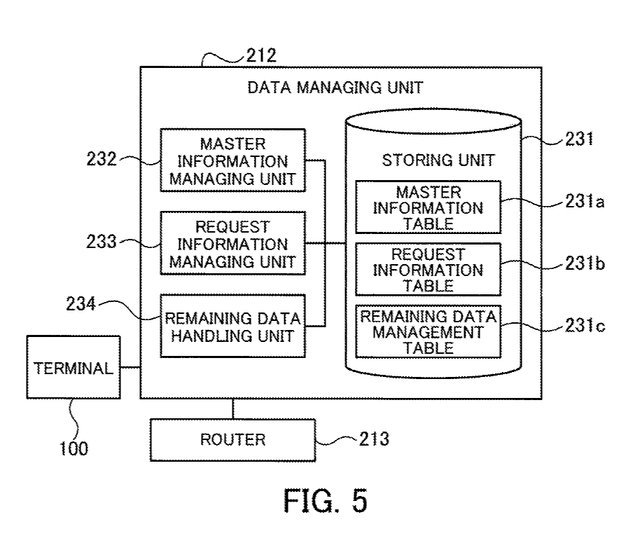

Further details of the functions of the data managing unit 212 are described next with reference to FIG. 5. FIG. 5 is a block diagram illustrating an example of functions of the data managing unit according to the second embodiment. The data managing unit 212 includes a storing unit 231, a master information managing unit 232, a request information managing unit 233, and a remaining data handling unit 234, as illustrated in FIG. 5. Functions of the storing unit 231 may be implemented using, for example, the RAM 906 or the storing unit 920 described above. Functions of the master information managing unit 232, the request information managing unit 233, and the remaining data handling unit 234 may be implemented using, for example, the CPU 902 described above.

The storing unit 231 stores therein a master information table 231a, a request information table 231b, and a remaining data management table 231c. The master information table 231a is used to store information on application software programs executed by the service delivering unit 211. For example, information indicating communication patterns associated with changes in charged amounts is registered in the master information table 231a. The information of the master information table 231a is set, for example, based on information about charged items (such as application software programs and services for recording logs in RDSs) provided by a PaaS provider.

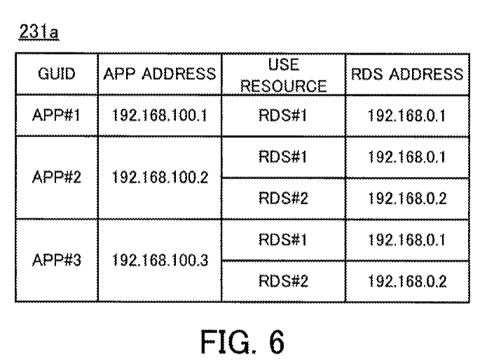

As illustrated in FIG. 6, the master information table 231a includes fields for, for example, GUIDs, APP addresses, use resources, and RDS addresses. Each GUID field contains the GUID for identifying an application software program. Each APP address field contains the IP address of the corresponding application software program (APP address) used by the application software program in HTTP communications. Each use resource field contains the storage resource used to record data, such as logs. Each RDS address field contains the IP address indicating the corresponding use resource (RDS address) in HTTP communications. FIG. 6 illustrates an example of the master information table according to the second embodiment.

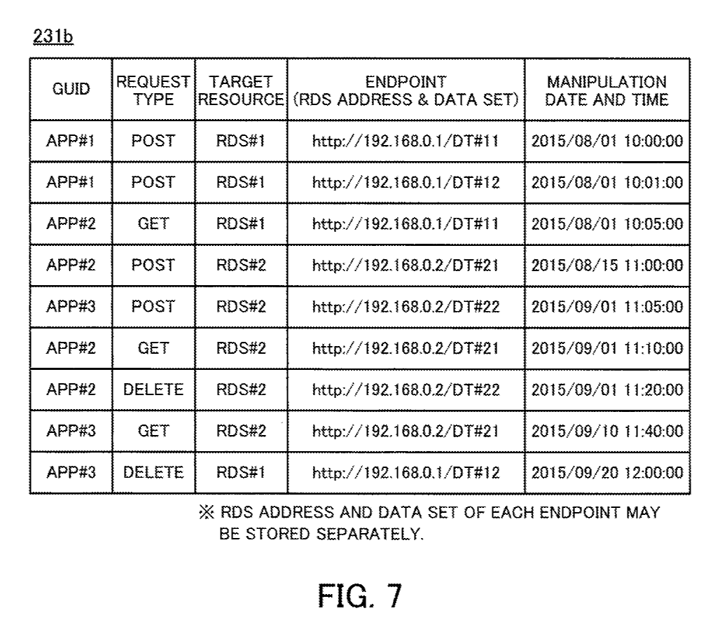

The request information table 231b is used to store results of monitoring HTTP communications performed via the router 213. As illustrated in FIG. 7, the request information table 231b includes fields for, for example, GUIDs of application software programs, request types, target resources, endpoints, and manipulation dates and times. A request type “POST” indicates an HTTP request for sending a data set to a target resource. A request type “GET” indicates an HTTP request for acquiring a data set from a target resource. A request type “DELETE” indicates an HTTP request for deleting a data set from a target resource. FIG. 7 illustrates an example of the request information table according to the second embodiment.

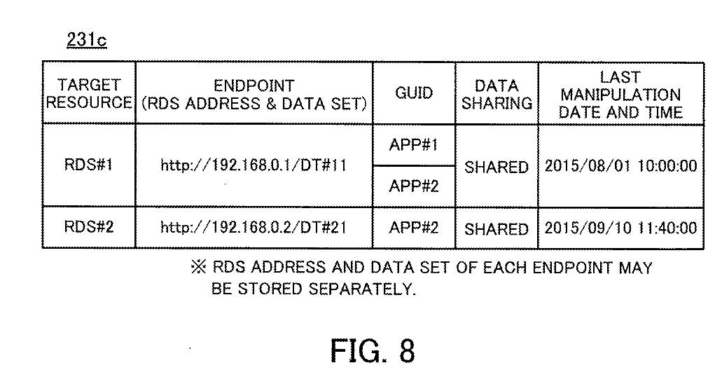

The remaining data management table 231c is used to store useful information for identifying deletable data sets at the time of cancellation of each application software program. As illustrated in FIG. 8, the remaining data management table 231c includes fields for, for example, target resources, endpoints, GUIDs, data sharing information, and last manipulation dates and times. Each data sharing field contains the information indicating whether the corresponding target data is shared among a plurality of application software programs (“shared” or “not shared”). FIG. 8 illustrates an example of the remaining data management table according to the second embodiment.

The master information managing unit 232 manages information of the master information table 231a (master information). For example, the master information managing unit 232 acquires information about charged items (such as application software programs and services for recording logs in RDSs) provided by the PaaS provider, and stores the master information in the master information table 231a based on the acquired information (see FIG. 6).

The request information managing unit 233 monitors HTTP communications performed via the router 213. In this regard, the request information managing unit 233 monitors each HTTP request having an APP address and an RDS address registered in the master information table 231a as its source and destination, respectively, as well as an HTTP response corresponding to the HTTP request. In addition, the request information managing unit 233 acquires the GUID, target resource, and request type from each HTTP request being monitored and the manipulation date and time and endpoint from the corresponding HTTP response, and records the acquired information in the request information table 231b.

Further, the request information managing unit 233 analyzes the information in the request information table 231b (request information), and records, in the remaining data management table 231c, useful information for identifying deletable data sets (remaining data information) at the time of cancellation of an application software program. Note that how to extract the remaining data information is described later. The remaining data handling unit 234 identifies deletable data sets associated with a cancelled application software program, based on the remaining data management table 231c, and deletes the identified data sets from appropriate RDS.

Note that the remaining data handling unit 234 may inform the user (the terminal 100) of information on the identified data sets, instead of deleting them from the RDS. In this case, based on the information sent from the remaining data handling unit 234, the user deletes the deletable data sets associated with the canceled application software program from the RDS. In this manner, identifying which data sets are deletable facilitates the user to delete the unwanted data sets by him/herself. The functions of the data managing unit 212 have been described thus far.

b-4. Flow of Processing

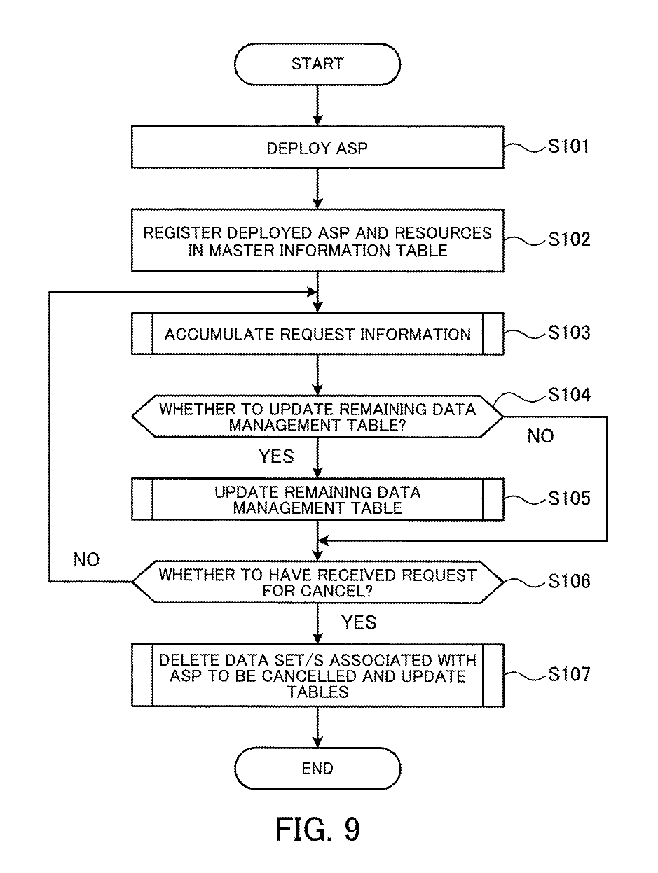

Next described is the flow of processing executed by the data managing unit 212, with reference to FIG. 9. Note that FIG. 9 is a first flow diagram illustrating the flow of processing executed by the data managing unit according to the second embodiment.

[Step S101] The user deploys an application software program (ASP, for short, in FIG. 9 and subsequent figures) to be charged on the cloud service delivery system 200 via the terminal 100. For example, the terminal 100 transmits, to the PaaS system 210, a request for registering a charging service and resources (for example, RDSs) used in developing and executing the application software program to be deployed.

[Step S102] The master information managing unit 232 registers the deployed application software program and the resources (RDSs) in the master information table 231a. Specifically, the master information managing unit 232 records, in the master information table 231a, the GUID of the application software program to be registered, the APP address of the application software program, the identification information of use resources (RDSs), and the RDS addresses (see FIG. 6).

[Step S103] The request information managing unit 233 monitors HTTP communications performed via the router 213, and accumulates request information in the request information table 231b. For example, the request information managing unit 233 acquires a source IP address and a destination IP address of each HTTP request. Then, the request information managing unit 233 sets, as a monitoring target, request information (each HTTP request) whose source IP address and destination IP address match an APP address and an RDS address, respectively, recorded in the master information table 231a. That is, the request information managing unit 233 identifies HTTP communications related to application software programs and their use resources to be charged as monitoring targets.

In addition, the request information managing unit 233 acquires, as request information, the GUID of the application software program, the target resource, and the request type from each monitoring-target HTTP request, and records the acquired information in the request information table 231b (see FIG. 7). Further, the request information managing unit 233 acquires, as request information, the manipulation date and time and the endpoint from an HTTP response corresponding to the monitoring-target HTTP request, and records the acquired information in the request information table 231b (see FIG. 7).

[Step S104] The request information managing unit 233 determines whether to update the remaining data management table 231c. For example, the request information managing unit 233 updates the remaining data management table 231c when a predetermined time (e.g. 3 minutes) has elapsed since the last update. If the request information managing unit 233 determines to update the remaining data management table 231c, the processing moves to step S105. On the other hand, if the request information managing unit 233 determines not to update the remaining data management table 231c, the processing moves to step S106.

[Step S105] The request information managing unit 233 carries out an update process of the remaining data management table 231c. With reference to the request information table 231b, the request information managing unit 233 identifies, for each application software program, the latest access (except for each request of “DELETE”) to a target data set at an endpoint. Then, the request information managing unit 233 records, in the remaining data management table 231c, information associating the application software program and the endpoint corresponding to the access-destination target data set (see FIG. 8).

In addition, with reference to the request information table 231b, the request information managing unit 233 deletes, from the remaining data management table 231c, each record related to a deleted target data set (i.e., a target data set for which a “DELETE” request has been received). Further, the request information managing unit 233 sorts out records of the request information table 231b by deleting therefrom each record related to information already recorded in the remaining data management table 231c.

[Step S106] The master information managing unit 232 determines whether to have received a request for cancelling an application software program from the terminal 100. If a request for cancelling an application software program has been received, the processing moves to step S107. On the other hand, if there is no request to cancel an application software program, the processing moves to step S103.

[Step S107] With reference to the remaining data management table 231c, the remaining data handling unit 234 identifies one or more endpoints associated with the application software program to be cancelled. In addition, the remaining data handling unit 234 determines whether the target data set at each identified endpoint is shared by a different application software program. If the target data set is not shared with another application software program, the remaining data handling unit 234 deletes the target data set from an appropriate RDS. Note that the remaining data handling unit 234 may inform the user (the terminal 100) of information about the target data set as a deletable target data set, instead of deleting it on its own.

The request information managing unit 233 deletes, from the request information table 231b and the remaining data management table 231c, information related to the application software program to be cancelled. In this regard, the request information managing unit 233 checks the sharing situation of the target data set and updates, within the remaining data management table 231c, information related to data sharing of the target data set (see FIG. 8; “shared” or “not shared”). After the completion of step S107, the series of processing illustrated in FIG. 9 ends.

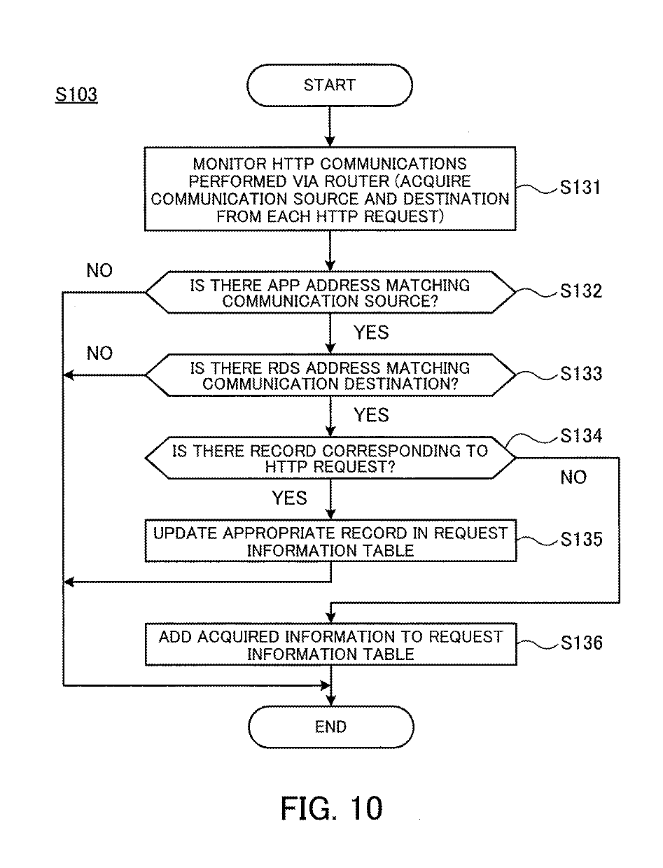

Further details of step S103 are described next with reference to FIG. 10. FIG. 10 is a second flow diagram illustrating the flow of processing executed by the data managing unit according to the second embodiment.

[Step S131] The request information managing unit 233 monitors HTTP communications performed via the router 213. In this regard, the request information managing unit 233 acquires the source IP address (communication source) and the destination IP address (communication destination) from each HTTP request.

[Step S132] With reference to the master information table 231a, the request information managing unit 233 determines whether an APP address matching the communication source is present. If an APP address matching the communication source is present, the process moves to step S133. On the other hand, if an APP address matching the communication source is absent from the master information table 231a, the series of processing illustrated in FIG. 10 ends.

[Step S133] With reference to the master information table 231a, the request information managing unit 233 determines whether an RDS address matching the communication destination is present. If an RDS address matching the communication destination is present, the process moves to step S134. On the other hand, if an RDS address matching the communication destination is absent from the master information table 231a, the series of processing illustrated in FIG. 10 ends. Note that the order of steps S132 and S133 may be reversed.

[Step S134] The request information managing unit 233 acquires the GUID of the application software program and the request type included in the HTTP request, and also acquires the endpoint included in an HTTP response corresponding to the HTTP request. Then, the request information managing unit 233 searches the request information table 231b for a record, the GUID, endpoint, and request type of which match the acquired GUID, endpoint, and request type, respectively. If an appropriate record is present, the processing moves to step S135. On the other hand, if such a record is absent, the processing moves to step S136.

[Step S135] The request information managing unit 233 updates the appropriate record in the request information table 231b. For example, the request information managing unit 233 updates the manipulation date and time of the record. After the completion of step S135, the series of processing illustrated in FIG. 10 ends.

[Step S136] The request information managing unit 233 adds, to the request information table 231b, a record associating the acquired GUID, request type, target resource, endpoint, and manipulation date and time with each other. After the completion of step S136, the series of processing illustrated in FIG. 10 ends. The details of step S103 have been described thus far.

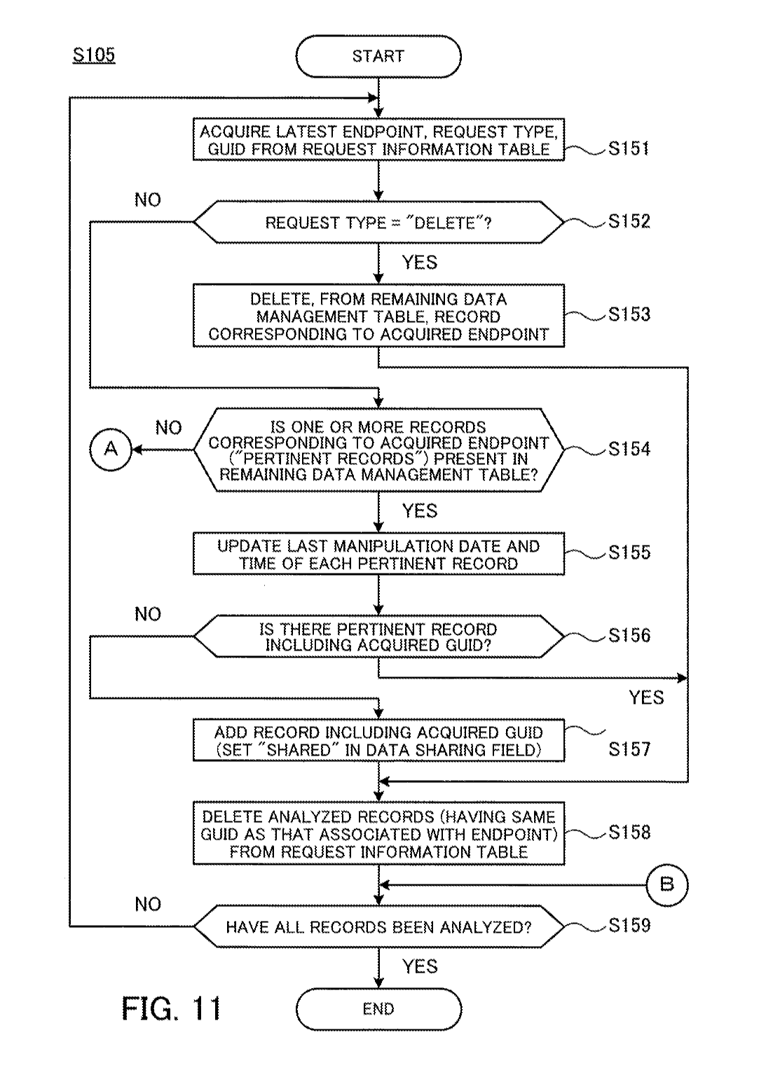

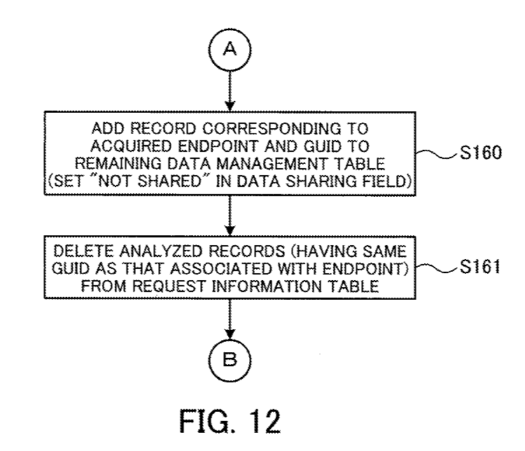

Further details of step S105 are described next with reference to FIGS. 11 and 12. FIG. 11 is a third flow diagram illustrating the flow of processing executed by the data managing unit according to the second embodiment. FIG. 12 is a fourth flow diagram illustrating the flow of processing executed by the data managing unit according to the second embodiment.

[Step S151] With reference to the request information table 231b, the request information managing unit 233 acquires the end point, request type, and GUID from a record with the latest manipulation date and time.

[Step S152] The request information managing unit 233 determines whether the request type acquired in step S151 is “DELETE” (i.e., a request asking for deletion of the corresponding target data set). If the request type is “DELETE”, the processing moves to step S153. On the other hand, if the request type is not “DELETE”, the process moves to step S154.

[Step S153] The request information managing unit 233 deletes, from the remaining data management table 231c, a record corresponding to the endpoint acquired in step S151. That is, because the latest manipulation is “DELETE” and the target data set has already been deleted from an appropriate RDS, the request information managing unit 233 deletes information related to the deleted target data set from the remaining data management table 231c. After the completion of step S153, the processing moves to step S158.

[Step S154] The request information managing unit 233 determines whether one or more records corresponding to the acquired endpoint (“pertinent records”) is present in the remaining data management table 231c. If such one or more pertinent records are present in the remaining data management table 231c, the processing moves to step S155. On the other hand, there is no pertinent record in the remaining data management table 231c, the processing moves to step S160 of FIG. 12.

[Step S155] The request information managing unit 233 updates the last manipulation date and time of each pertinent record in the remaining data management table 231c with the manipulation date and time recorded in the request information table 231b in association with the acquired endpoint and the like.

[Step S156] The request information managing unit 233 determines whether there is, amongst the pertinent records in the remaining data management table 231c, the last manipulation date and time of which is updated in step S155, a pertinent record including the GUID acquired in step S151. If a pertinent record including the acquired GUID is present, the processing moves to step S158. On the other hand, if a pertinent record including the acquired GUID is absent, the processing moves to step S157.

[Step S157] The request information managing unit 233 adds a record including the acquired GUID to the remaining data management table 231c. Specifically, the request information managing unit 233 adds information of the acquired GUID to an existing record corresponding to the acquired endpoint (for example, see the record corresponding to RDS#1 of FIG. 8). In this regard, the request information managing unit 233 sets “shared” in the data sharing field of the pertinent record.

Step S157 is carried out when one or more records corresponding to the acquired endpoint are present in the remaining data management table 231c (Yes in step S154) but no pertinent record including the acquired GUID is present (No in step S156). That is, step S157 is performed when the acquired endpoint has already been associated with the GUID of another application software program. Because the application software program with the acquired GUID also uses the target data set at the endpoint, the target data set is shared by a plurality of application software programs. Therefore, “shared” is set in the data sharing field, as described above.

[Step S158] The request information managing unit 233 deletes one or more analyzed records (i.e., records having the same GUID as that associated with the endpoint) from the request information table 231b. The reason for providing the request information table 231b and the remaining data management table 231c is to associate application software programs with target data sets located at endpoints. Therefore, once association information (a mapping between an endpoint and a GUID) is stored in the remaining data management table 231c, old request information used to extract the association information is no longer needed. Hence, the request information managing unit 233 deletes such analyzed records from the request information table 231b to save the storage space.

[Step S159] The request information managing unit 233 determines whether to have analyzed all the records in the request information table 231b. If all the records have been analyzed, the series of processing illustrated in FIGS. 11 and 12 ends. On the other hand, if one or more records remain unanalyzed, the processing moves to step S151.

[Step S160] The request information managing unit 233 adds a record corresponding to the acquired endpoint and GUID to the remaining data management table 231c. In this regard, the request information managing unit 233 sets “not shared” in the data sharing field of the added record. Step S160 is carried out when one or more records corresponding to the acquired endpoint are absent from the remaining data management table 231c (No in step S154). That is, step S160 is performed when the acquired endpoint has yet to be associated with the GUID of another application software program. Because only the application software program with the acquired GUID currently uses the target data set, “not shared” is set in the data sharing field of the added filed, as described above.

[Step S161] The request information managing unit 233 deletes one or more analyzed records (i.e., records having the same GUID as that associated with the endpoint) from the request information table 231b. After the completion of step S161, the processing moves to step S159 of FIG. 11. The details of step S105 have been described thus far.

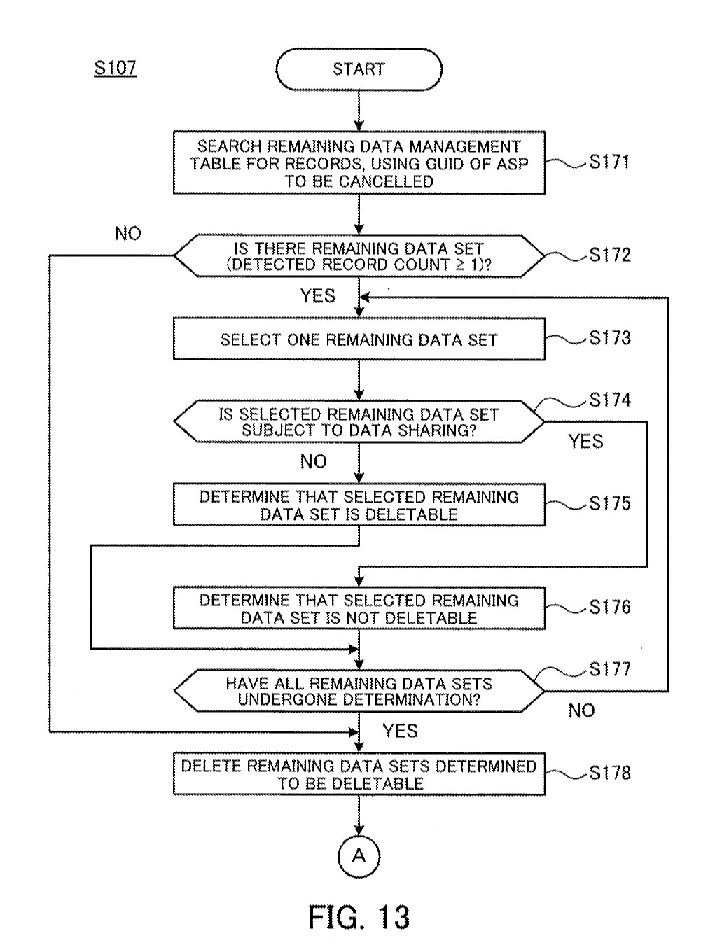

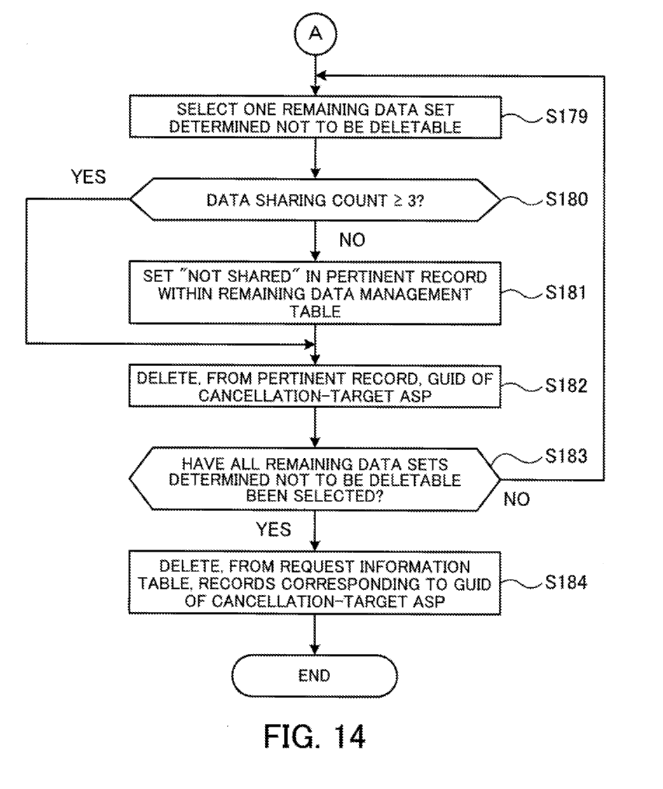

Further details of step S107 are described next with reference to FIGS. 13 and 14. FIG. 13 is a fifth flow diagram illustrating the flow of processing executed by the data managing unit according to the second embodiment. FIG. 14 is a sixth flow diagram illustrating the flow of processing executed by the data managing unit according to the second embodiment.

[Step S171] Using the GUID of the application software program to be cancelled (the “cancellation-target application software program”), the remaining data handling unit 234 searches the remaining data management table 231c for one or more records.

[Step S172] The remaining data handling unit 234 determines whether there is one or more target data sets associated with the cancellation-target application software program (“remaining data sets”). For example, the remaining data handling unit 234 determines whether the number of records detected from the remaining data management table 231c in step S171 (the “detected record count”) is equal to or more than 1. If the detected record count is equal to or more than 1 (i.e., there is one or more remaining data sets), the processing moves to step S173. On the other hand, if the detected record count is 0 (there is no remaining data set), the processing moves to step S178.

[Step S173] The remaining data handling unit 234 selects one remaining data set.

[Step S174] With reference to the remaining data management table 231c, the remaining data handling unit 234 determines whether “shared” is set in the data sharing field of the record corresponding to the selected remaining data set. If “shared” is set, the processing moves to step S176. On the other hand, if “not shared” is set, the processing moves to step S175.

[Step S175] The remaining data handling unit 234 determines that the selected remaining data set is deletable. That is, when no application software program other than the cancellation-target application software program is associated with the remaining data set, the remaining data set is eligible for deletion. After the completion of step S175, the processing moves to step S177.

[Step S176] The remaining data handling unit 234 determines that the selected remaining data set is not deletable. That is, when an application software program other than the cancellation-target application software program is associated with the remaining data set, the remaining data set is excluded from deletion targets.

[Step S177] The remaining data handling unit 234 determines whether all the remaining data sets have undergone the deletion determination. If all the remaining data sets have undergone the deletion determination, the processing moves to step S178. On the other hand, if one or more remaining data sets have yet to undergo the deletion determination, the processing moves to step S173.

[Step S178] The remaining data handling unit 234 deletes remaining data sets determined to be deletable from appropriate RDSs. In addition, the request information managing unit 233 deletes, from the remaining data management table 231c, records corresponding to the remaining data sets determined to be deletable. Note that the remaining data handling unit 234 may inform the user (the terminal 100) of information on the remaining data sets determined to be deletable, instead of deleting them on its own from the RDS, and ask the user to handle the deletion of the remaining data sets. After the completion of step S178, the processing moves to step S179 of FIG. 14.

[Step S179] The request information managing unit 233 selects one remaining data set determined by the remaining data handling unit 234 not to be deletable.

[Step S180] With reference to the remaining data management table 231c, the request information managing unit 233 determines whether the data sharing count of the selected remaining data set (i.e., the number of application software programs sharing the selected remaining data set) is three or more. That is, the request information managing unit 233 checks whether the number of application software programs associated with the remaining data set is two or more after the association between the cancellation-target application software program and the remaining data set is dissolved. If the data sharing count is three or more, the processing moves to step S182. On the other hand, if the data sharing count is not three or more, the processing moves to step S181.

[Step S181] The request information managing unit 233 sets, within the remaining data management table 231c, “not shared” in the data sharing field of a record corresponding to the selected remaining data set (a “pertinent record”).

[Step S182] The request information managing unit 233 deletes the GUID of the cancellation-target application software program from the pertinent record within the remaining data management table 231c.

[Step S183] The request information managing unit 233 determines whether all the remaining data sets determined not to be deletable have been selected. If all the remaining data sets determined not to be deletable have been selected, the processing moves to step S184. On the other hand, if one or more of the remaining data sets determined not to be deletable remain unselected, the processing moves to step S179.

[Step S184] The request information managing unit 233 deletes, from the request information table 231b, one or more records corresponding to the GUID of the cancellation-target application software program. After the completion of step S184, the series of processing illustrated in FIGS. 13 and 14 ends. The details of step S107 have been described thus far. The flow of processing executed by the data managing unit 212 has been described thus far.

### (c) Modification: Case of Accessing Data Sets Via Services

Next described is a modification of the second embodiment. In the above-described example, application software programs directly access RDSs; however, the modification is directed to the case where application software programs access RDSs via services.

c-1. Master Information Table

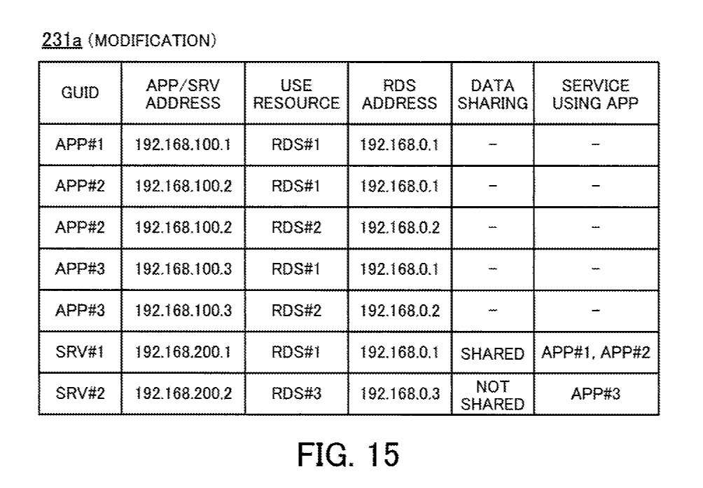

In the case where application software programs access RDSs via services, the above-described technique of the second embodiment is applicable by modifying the master information table 231a as illustrated in FIG. 15. FIG. 15 illustrates an example of the master information table according to the modification of the second embodiment. As illustrated in FIG. 15, the master information table 231a according to the modification includes GUIDs of services (SRV#1 and SRV#2) in addition to GUIDs of application software programs (APP#1, APP#2, and APP#3). Each record corresponding to a service in the master information table 231a includes information about the state of data sharing and one or more service using APPs (one or more application software programs using the corresponding service to access an appropriate RDS). For example, in the case where APP#1 and APP#2 use SRV#1 to access RDS#1, the record corresponding to SRV#1 includes “shared” in its data sharing field.

c-2. Flow of Processing

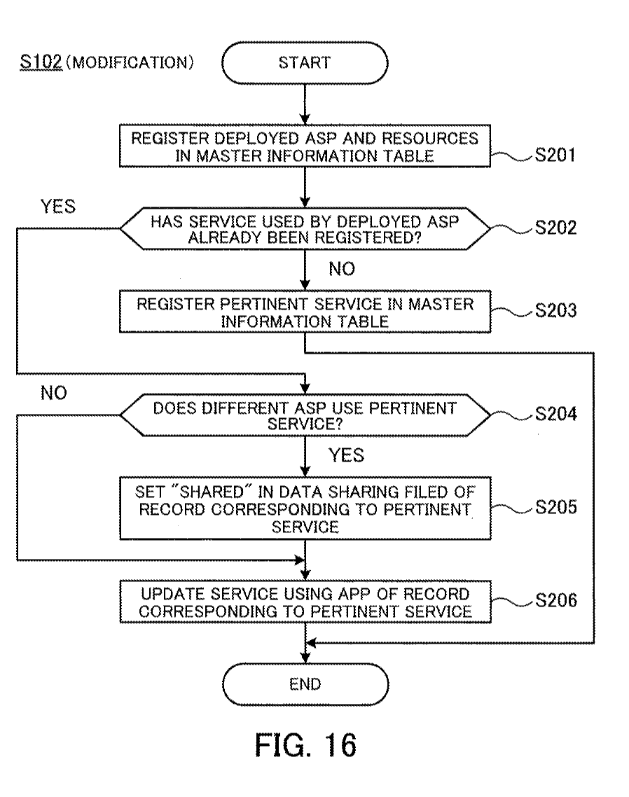

In addition to the modification of the master information table 231a, steps S102 and S107 among the above-described processing steps carried out by the data managing unit 212 are modified. First, the modification of step S102 is described with reference to FIG. 16. FIG. 16 is a first flow diagram illustrating the flow of processing executed by the data managing unit according to the modification of the second embodiment.

[Step S201] The master information managing unit 232 registers the deployed application software program and the resources (RDSs) in the master information table 231a. Specifically, the master information managing unit 232 records, in the master information table 231a, the GUID of the application software program to be registered, the APP address of the application software program, the identification information of use resource (RDS), and the RDS addresses (see FIG. 15).

In addition, the master information managing unit 232 sets the life cycle period (e.g. one month) of data sets. The life cycle period is set, for example, based on the charging span of the use resource (RDS). Note that the life cycle period is used to determine whether a data set is deletable by comparing it with the time having elapsed since the last update of the data set.

[Step S202] The master information managing unit 232 determines whether a service used by the deployed application software program (a “pertinent service”) has already been registered in the master information table 231a. If the pertinent service has already been registered in the master information table 231a, the processing moves to step S204. On the other hand, if the pertinent service has yet to be registered in the master information table 231a, the processing moves to step S203.

[Step S203] The master information managing unit 232 registers the pertinent service in the master information table 231a. In this regard, the master information managing unit 232 registers, in the master information table 231a, the GUID of the pertinent service; the IP address identifying the pertinent service (SRV address); the use resource (RDS) accessed by the pertinent service; and the RDS address of the use resource. In addition, the master information managing unit 232 adds the deployed application software program to the service using APP field, and sets “not shared” in the data sharing field. After the completion of step S203, the series of processing illustrated in FIG. 16 ends.

[Step S204] With reference to the master information table 231a, the master information managing unit 232 determines whether a different application software program uses the pertinent service. If another application software program uses the pertinent service, the processing moves to step S205. On the other hand, if no other application software program uses the pertinent service, the processing moves to step S206.

[Step S205] The master information managing unit 232 sets “shared” in the data sharing field of the record corresponding to the pertinent service within the master information table 231a. That is, because the pertinent service is shared between the deployed application software program and the different application software program, data sets in the RDS accessed via the pertinent service are likely to be shared by these two software programs. Therefore, “shared” is set in the data sharing field of the record corresponding to the pertinent service.

[Step S206] The master information managing unit 232 adds, within the master information table 231a, the deployed application software program to the service using APP field of the record corresponding to the pertinent service, to thereby update the service using APP field.

After the completion of step S206, the series of processing illustrated in FIG. 16 ends. The modification of step S102 has been described thus far.

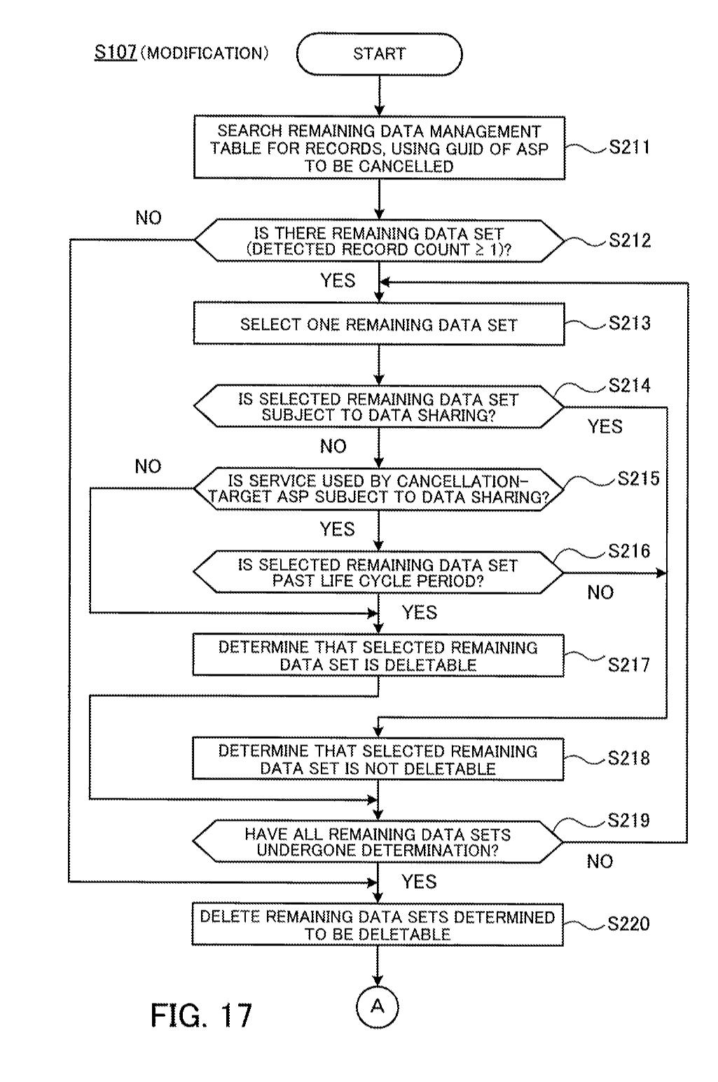

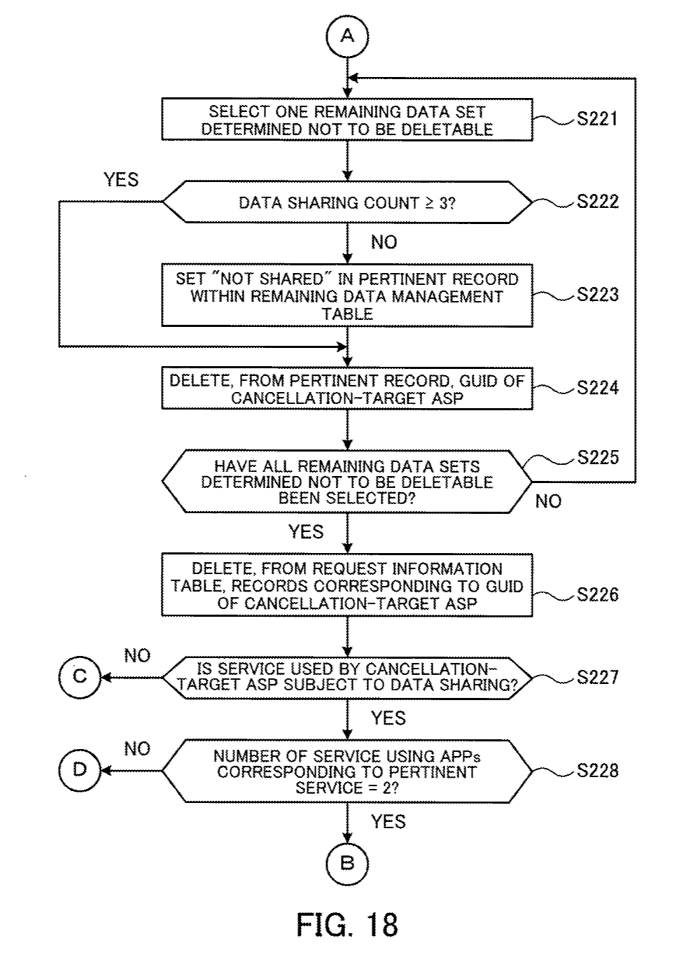

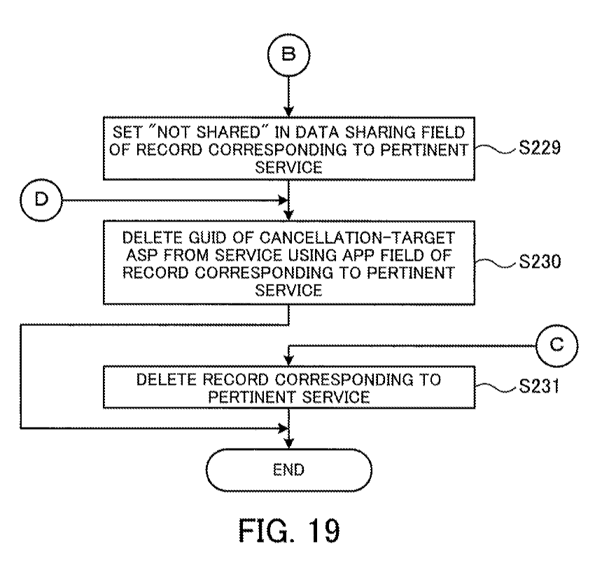

The modification of step S107 is described next with reference to FIGS. 17 to 19. FIG. 17 is a second flow diagram illustrating the flow of the processing executed by the data managing unit according to the modification of the second embodiment. FIG. 18 is a third flow diagram illustrating the flow of the processing executed by the data managing unit according to the modification of the second embodiment. FIG. 19 is a fourth flow diagram illustrating the flow of the processing executed by the data managing unit according to the modification of the second embodiment.

[Step S211] Using the GUID of the cancellation-target application software program, the remaining data handling unit 234 searches the remaining data management table 231c for one or more records.

[Step S212] The remaining data handling unit 234 determines whether there is one or more target data sets associated with the cancellation-target application software program (“remaining data sets”). For example, the remaining data handling unit 234 determines whether the number of records detected from the remaining data management table 231c in step S211 (the “detected record count”) is equal to or more than 1. If the detected record count is equal to or more than 1 (i.e., there is one or more remaining data sets), the processing moves to step S213. On the other hand, if the detected record count is 0 (there is no remaining data set), the processing moves to step S220.

[Step S213] The remaining data handling unit 234 selects one remaining data set.

[Step S214] With reference to the remaining data management table 231c, the remaining data handling unit 234 determines whether “shared” is set in the data sharing field of the record corresponding to the selected remaining data set. If “shared” is set, the processing moves to step S218. On the other hand, if “not shared” is set, the processing moves to step S215.

[Step S215] With reference to the master information table 231a, the remaining data handling unit 234 determines whether “shared” is set in the data sharing field of a record corresponding to a service used by the cancellation-target application software program (a “pertinent service”). If “shared” is set, the processing moves to step S216. On the other hand, if “not shared” is set, the processing moves to step S217.

[Step S216] The remaining data handling unit 234 determines whether the selected remaining data set is past the life cycle period. For example, with reference to the remaining data management table 231c, the remaining data handling unit 234 calculates the difference between the last manipulation date and time and the current date and time. Then, if the difference is larger than the life cycle period, the remaining data handling unit 234 determines that the selected remaining data set is past the life cycle period. If the selected remaining data set is past the life cycle period, the processing moves to step S217. On the other hand, if the selected remaining data set has not reached the life cycle period, the processing moves to step S218.

[Step S217] The remaining data handling unit 234 determines that the selected remaining data set is deletable. That is, the selected remaining data set is determined to be deletable in the case where one of the following conditions is met. The first condition is that an application software program other than the cancellation-target application software program is not associated with the remaining data set as well as there is no sharing of the pertinent service. The second condition is that an application software program other than the cancellation-target application software program is not associated with the remaining data set and the remaining data set is past the life cycle period even though there is sharing of the pertinent service. After the completion of step S217, the processing moves to step S219.

[Step S218] The remaining data handling unit 234 determines that the selected remaining data set is not deletable. That is, the selected remaining data set is determined not to be deletable in the case where one of the following conditions is met. The first condition is that an application software program other than the cancellation-target application software program is associated with the remaining data set. The second condition is that, even though an application software program other than the cancellation-target application software program is not associated with the remaining data set, there is sharing of the pertinent service and the remaining data set has not reached the life cycle period.

[Step S219] The remaining data handling unit 234 determines whether all the remaining data sets have undergone the deletion determination. If all the remaining data sets have undergone the deletion determination, the processing moves to step S220. On the other hand, if one or more remaining data sets have yet to undergo the deletion determination, the processing moves to step S213.

[Step S220] The remaining data handling unit 234 deletes remaining data sets determined to be deletable from appropriate RDSs. In addition, the request information managing unit 233 deletes, from the remaining data management table 231c, records corresponding to the remaining data sets determined to be deletable. Note that the remaining data handling unit 234 may inform the user (the terminal 100) of information on the remaining data sets determined to be deletable, instead of deleting them on its own from the RDS, and ask the user to handle the deletion of the remaining data sets. After the completion of step S220, the processing moves to step S221 of FIG. 18.

[Step S221] The request information managing unit 233 selects one remaining data set determined by the remaining data handling unit 234 not to be deletable.

[Step S222] With reference to the remaining data management table 231c, the request information managing unit 233 determines whether the data sharing count of the selected remaining data set (i.e., the number of application software programs sharing the selected remaining data set) is three or more. That is, the request information managing unit 233 checks whether the number of application software programs associated with the remaining data set is two or more after the association between the cancellation-target application software program and the remaining data set is dissolved. If the data sharing count is three of more, the processing moves to step S224. On the other hand, if the data sharing count is not three or more, the processing moves to step S223.

[Step S223] The request information managing unit 233 sets, within the remaining data management table 231c, “not shared” in the data sharing field of a record corresponding to the selected remaining data set (a “pertinent record”).

[Step S224] The request information managing unit 233 deletes the GUID of the cancellation-target application software program from the pertinent record within the remaining data management table 231c.

[Step S225] The request information managing unit 233 determines whether all the remaining data sets determined not to be deletable have been selected. If all the remaining data sets determined not to be deletable have been selected, the processing moves to step S226. On the other hand, if one or more of the remaining data sets determined not to be deletable remain unselected, the processing moves to step S221.

[Step S226] The request information managing unit 233 deletes, from the request information table 231b, one or more records corresponding to the GUID of the cancellation-target application software program.

[Step S227] With reference to the master information table 231a, the master information managing unit 232 determines whether “shared” is set in the data sharing field of the record corresponding to the service used by the cancellation-target application software program (the “pertinent service”). If “shared” is set, the processing moves to step S228. On the other hand, if “not shared” is set, the processing moves to step S231 of FIG. 19.

[Step S228] With reference to the master information table 231a, the master information managing unit 232 determines whether there are two service using APPs corresponding to the pertinent service (i.e., whether there are two application software programs using the pertinent service). If there are two service using APPs corresponding to the pertinent service, the processing moves to step S229 of FIG. 19. On the other hand, if the number of service using APPs corresponding to the pertinent service is not two, the processing moves to step S230 of FIG. 19.

[Step S229] The master information managing unit 232 updates, within the master information table 231a, the record corresponding to the pertinent service by setting “not shared” in the data sharing field of the record.

[Step S230] The master information managing unit 232 deletes the GUID of the cancellation-target application software program from the service using APP field of the pertinent service, to thereby update the master information table 231a. After the completion of step S230, the series of processing illustrated in FIGS. 17 to 19 ends.

[Step S231] The master information managing unit 232 deletes the record of the pertinent service from the master information table 231a. After the completion of step S231, the series of processing illustrated in FIGS. 17 to 19 ends. The details of the modification of step S107 have been described thus far. The modification has been described thus far.

c-3. Other Particulars

Resource charging systems include, for example, pay-as-you-go systems, such as object storage services, and pay-monthly systems for leasing a storage space. For example, in the case of a pay-monthly system for leasing a storage space, if a reduction in the leased storage space is unlikely to cause any problem after remaining data sets are accurately deleted, the data managing unit 212 may carry out an update process to automatically reduce the leased storage space.

In addition, the following scheme may be used to cut the monthly usage fee. First, the data managing unit 212 (1) creates storage/instance with small capacity; (2) backs up/exports data of an instance in use; and (3) restores/imports the data of (2) to the new instance. Then, the data managing unit 212 (4) changes the instance to which an application is connected to the instance of (3); and (5) deletes the storage/instance no longer used.

Herewith, it is possible to reduce the monthly usage fee. The above-described application is also within the technical scope of the second embodiment. The second embodiment has been described thus far.

According to one aspect, it is possible to reduce the occurrence of deletable data sets associated with a processing program being left at the termination of the use of the processing program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer program that causes a processor of a computer including a memory to perform a process comprising:
storing a management information piece in the memory each time a request for manipulation issued during execution of each processing program used for data manipulation is a request for acquisition, reference, or update of a data set, the management information piece associating the processing program with the data set targeted for the manipulation;
identifying, upon input of notice indicating termination of use of a first processing program into the computer, one or more data sets associated with the first processing program based on one or more management information pieces corresponding to the first processing program; and
determining, for each of the identified data sets, that the identified data set is deletable when, in the memory, there is no management information piece corresponding to a second processing program being different from the first processing program and associated with the identified data set.

2. The non-transitory computer-readable storage medium according to claim 1, wherein:
each management information piece further associates the processing program and the data set corresponding to the management information piece with an access destination for the corresponding data set,
the storing includes storing, when a management information piece associating the processing program and the data set related to the issued request with the access destination for the related data set is absent from the memory, the management information piece in the memory, and
the process further includes deleting, from the memory, when a deletion request for deleting a data set is issued during the execution of each processing program, a management information piece associating the processing program and the data set related to the deletion request with the access destination for the related data set.

3. The non-transitory computer-readable storage medium according to claim 1, wherein:
one or more setting information pieces are stored in the memory, each of the setting information pieces associating a service used for data access with one or more processing programs using the service, and
the determining includes determining, for each of the identified data sets, that the identified data set is deletable when, in the memory, there is no management information piece corresponding to the second processing program associated with the identified data set as well as there is no setting information piece corresponding to the second processing program associated with a service used by the first processing program.

4. The non-transitory computer-readable storage medium according to claim 1, wherein:
one or more setting information pieces are stored in the memory, each of the setting information pieces associating a service used for data access with one or more processing programs using the service,
a lifetime is set for each data set,
each management information piece further associates the processing program and the data set corresponding to the management information piece with an access destination for the corresponding data set and an updated date and time of the corresponding data set, and
the determining includes determining, for each of the identified data sets, that the identified data set is deletable when, in the memory, there is no management information piece corresponding to the second processing program associated with the identified data set, then there is a setting information piece corresponding to the second processing program associated with a service used by the first processing program, and the lifetime of the identified data set has expired.

5. A data management apparatus comprising:
a memory; and
a processor configured to perform a process including:
storing a management information piece in the memory each time a request for manipulation issued during execution of each processing program used for data manipulation is a request for acquisition, reference, or update of a data set, the management information piece associating the processing program with the data set targeted for the manipulation,
identifying, upon input of notice indicating termination of use of a first processing program into the data management apparatus, one or more data sets associated with the first processing program based on one or more management information pieces corresponding to the first processing program, and
determining, for each of the identified data sets, that the identified data set is deletable when, in the memory, there is no management information piece corresponding to a second processing program being different from the first processing program and associated with the identified data set.

6. A data management method comprising:
storing, by a processor of a computer including a memory, a management information piece in the memory each time a request for manipulation issued during execution of each processing program used for data manipulation is a request for acquisition, reference, or update of a data set, the management information piece associating the processing program with the data set targeted for the manipulation;
identifying, by the processor, upon input of notice indicating termination of use of a first processing program into the computer, one or more data sets associated with the first processing program based on one or more management information pieces corresponding to the first processing program; and
determining, by the processor, for each of the identified data sets, that the identified data set is deletable when, in the memory, there is no management information piece corresponding to a second processing program being different from the first processing program and associated with the identified data set.
